(19) United States
(12) Patent Application Publication
(10) Pub. No.: US 2024/0019272 A1
(43) Pub. Date: Jan. 18, 2024

(54) A METHOD OF MONITORING POSITION USING A MAGNETIC SENSOR SYSTEM

(71) Applicant: Analog Devices International Unlimited Company, Limerick (IE)

(72) Inventors: Jochen SCHMITT, Biedenkopf (DE); Gavin COSGRAVE, Enniscorthy (IE); Enda Joseph NICHOLL, Kilmallock (IE); Christian NAU, Marburg (DE); Stephen BRADSHAW, Berkshire (GB); Katherine O'RIORDAN, Clarina (IE)

(21) Appl. No.: 18/247,621

(22) PCT Filed: Oct. 2, 2020
(86) PCT No.: PCT/EP2020/077713

§ 371 Date: Mar. 31, 2023

(51) Int. Cl. G01D 5/16; G01B 7/30

(52) U.S. Cl. CPC G01D 5/16; G01B 7/30

(57) ABSTRACT

The present disclosure provides a linear actuator apparatus, magnetic sensor system and method of use for detecting a position of a component driven by a rotatable mechanism in a linear direction. A magnetic sensing device comprising both a multi-turn (MT) sensor and a single turn (ST) sensor is provided within the same semiconductor package and placed in the vicinity of the rotatable mechanism. A magnet is mounted on the rotatable mechanism, such that, as the mechanism rotates, a rotating magnetic field is generated. The MT sensor measures the number of turns of the rotating magnetic field, which is translated to the number of turns of the rotatable mechanism. The ST sensor measures the angle of the rotating magnetic field, which is translated to an angular position of the rotatable mechanism. As each turn of the rotatable mechanism will be translated to a specific amount of linear motion, the amount by which the rotational mechanism has turned is proportional to the distance travelled by the driven component, and thus indicative of the linear position. Therefore, by placing a magnet and the magnetic sensing device in relation to the rotatable mechanism, with the multi-turn sensor providing the number of turns and the angle sensor providing the precise angular position within each turn, the measured rotational position can be translated to a corresponding linear position of the element being moved linearly as a result of the rotation.

### FIELD OF DISCLOSURE

The present disclosure relates to a linear actuator, magnetic sensor system and method of use. In particular, the present disclosure relates to a magnetic sensor system and method of use for monitoring the position a component driven by a rotatable mechanism in a linear direction.

### BACKGROUND

Magnetic sensor systems comprising single turn angle sensors and multi-turn sensors are commonly used in applications where there is a need to monitor both the number of times a device has been turned and its precise angular position. An example is a steering wheel in a vehicle. Magnetic multi-turn sensors typically include magnetoresistive elements that are sensitive to an applied external magnetic field. The resistance of the magnetoresistive elements can be changed by rotating a magnetic field within the vicinity of the sensor. Variations in the resistance of the magnetoresistive elements will be tracked to determine the number of turns in the magnetic fields, which can be translated to a number of turns in the device being monitored. Similarly, magnetic single turn sensors measure the magnetic field angle of the rotating magnetic field, which can be translated to an angular position of the device being monitored.

### SUMMARY OF DISCLOSURE

The present disclosure provides a linear actuator apparatus, magnetic sensor system and method of use for detecting a position of a component driven by a rotatable mechanism in a linear direction. A magnetic sensing device comprising both a multi-turn (MT) sensor and a single turn (ST) sensor is provided within the same semiconductor package and placed in the vicinity of the rotatable mechanism. A magnet is mounted on the rotatable mechanism, such that, as the mechanism rotates, a rotating magnetic field is generated. The MT sensor measures the number of turns of the rotating magnetic field, which is translated to the number of turns of the rotatable mechanism. The ST sensor measures the angle of the rotating magnetic field, which is translated to an angular position of the rotatable mechanism. As each turn of the rotatable mechanism will be translated to a specific amount of linear motion, the amount by which the rotational mechanism has turned is proportional to the distance travelled by the driven component, and thus indicative of the linear position. Therefore, by placing a magnet and the magnetic sensing device in relation to the rotatable mechanism, with the multi-turn sensor providing the number of turns and the angle sensor providing the precise angular position within each turn, the measured rotational position can be translated to a corresponding linear position of the element being moved linearly as a result of the rotation.

Such an arrangement provides a compact and robust device for measuring linear position, which removes the need for installing a linear position system on the linearly driven component.

A first aspect of the present disclosure provides a linear actuator apparatus, comprising:
a first component for actuating a system in a linear direction;
a rotatable mechanism configured to drive the first component in the linear direction;
a magnet mounted on the rotatable mechanism; and
at least one magnetic sensing device in the vicinity of the magnet, the at least one magnetic sensing device comprising:
   an angle sensor configured to detect an orientation of the magnetic field generated by the magnet as the rotatable mechanism is rotated; and
   a multi-turn sensor configured to detect a number of turns of the magnet as the rotatable mechanism is rotated;
wherein the at least on magnetic sensing device is configured to output a position of the first component in the linear direction based on the detected orientation of the magnetic field and the detected number of turns.

The angle sensor and the multi-turn sensor are preferably arranged on a first integrated circuit board. That is to say, the multi-turn sensor and angle sensor are provided in the same magnetic sensor package, which can be easily installed in proximity to the magnet without taking up a significant amount of space.

The at least one magnetic sensing device may further comprise processing means for determining the position of the first component in the linear direction.

The angle sensor is preferably configured to detect the orientation of the magnetic field over a range of 0° to 180°. That is to say, the angle sensor will determine the absolute angle position within each half turn.

The angle sensor may be one of: an anisotropic magnetoresistive (AMR) based single turn sensor, a giant magnetoresistive (GMR) based single turn sensor, a tunnel magnetoresistive (TMR) based single turn sensor, a Hall effect sensor and an inductive sensor.

The multi-turn sensor may be a giant magnetoresistive (GMR) based multi-turn sensor, or a tunnel magnetoresistive (TMR) based multi-turn sensor.

The multi-turn sensor may comprise a plurality of magnetoresistive elements electrically connected in series and physically laid out in a spiral configuration.

In such cases, the multi-turn sensor may further comprise a matrix of electrical connections arranged to electrically connect magnetoresistive elements of the plurality of magnetoresistive elements to other magnetoresistive elements of the plurality of magnetoresistive elements, the matrix being at least three by three.

The rotatable mechanism may comprise a first cylindrical gear, and wherein the first component comprises a linear gear configured to cooperate with the first cylindrical gear, such that rotation of the first cylindrical gear causes the linear gear to translate in a linear direction. For example, each gear may comprise teeth that cooperate together, to thereby provide a rack and pinion arrangement.

The rotatable mechanism may further comprise a second cylindrical gear configured to cooperate with the first cylindrical gear, such that rotation of the second cylindrical gear causes a corresponding rotation of the first cylindrical gear.

In such cases, the magnet may be mounted in relation to the first cylindrical gear or the second cylindrical gear. As such, the magnet will rotate with one of the gears, thereby generating a rotating magnetic field, the magnetic sensing device therefore monitoring the rotation of whichever gear the magnet is mounted on.

The rotatable mechanism may comprise a threaded screw and a cylindrical gear, wherein the threaded screw is configured to cooperate with the cylindrical gear such that rotation of the threaded screw causes a rotation of the cylindrical gear. For example, the rotatable mechanism may be a worm drive arrangement comprising a worm and worm gear.

In such arrangements, the first component may then comprise a linear gear configured to cooperate with the cylindrical gear, such that rotation of the cylindrical gear causes the linear gear to translate in a linear direction.

In other arrangements, the rotatable mechanism may comprise a threaded shaft, wherein the first component comprises an annular part arranged around the threaded shaft and configured to engage with the threaded shaft such that rotation of the threaded shaft causes the annular part to translate in a linear direction along the threaded shaft. An example of such an arrangement is a leadscrew with a nut that moves along the leadscrew as it rotates.

In some cases, the threaded shaft may further comprise a gear arrangement configured to drive the rotation of the threaded shaft. In such cases, the magnet may be mounted on the gear arrangement.

The magnet may be a single pole pair magnet or a multi-pole magnet.

In cases where the magnet is a multi-pole ring magnet, the at least one magnetic sensing device may be located in a first position adjacent to an outer circumferential edge of the multi-pole magnet, and/or a second position in front of the multi-pole magnet aligned with a pole pair.

The linear actuator apparatus may further comprise a motor configured to drive the rotatable mechanism.

The linear actuator apparatus may further comprise an electromagnet for initialising the angle sensor and multi-turn sensor.

The linear actuator apparatus may further comprise a protective shield formed around the magnet and magnetic sensing device. For example, the protective shield may comprise a ferromagnetic material. This shields the sensing device from stray magnetic fields that could cause a false reading.

The linear actuator apparatus may further comprise a linear sensor system. For example, the linear sensor system may comprise an incremental linear track comprising a first number of magnetic poles, and a further magnetic sensing device configured to count the first number of magnetic poles.

A second aspect of the present disclosure provides a method of monitoring position using a magnetic sensing device, wherein a magnet is mounted on a rotatable mechanism configured to actuate a first component in a linear direction, the method comprising:
detecting, using an angle sensor, an orientation of a magnetic field generated by the magnet as the rotatable mechanism is rotated;
detecting, using a multi-turn sensor, number of turns of the magnet as the rotatable mechanism is rotated; and
determining a position of the first component in the linear direction based on the detected orientation and detected number of turns.

Determining the position of the first component in the linear direction may comprise determining an amount of rotation by the rotatable mechanism in a first direction, and determining a distance travelled by the first component in the linear direction based on the determined amount of rotation. In this respect, the amount of rotation by the rotatable mechanism is proportional to the distance travelled by the first component, and thus the measured rotation can be directly translated to a linear position.

The angle sensor and the multi-turn sensor are preferably arranged on a first integrated circuit board.

Detecting the orientation of the magnetic field preferably comprises detecting the orientation of the magnetic field over a range of 0° to 180°.

The method may further comprise initialising the angle sensor and/or multi-turn sensor when the first component is at a starting position.

A further aspect of the present disclosure provides a computer system comprising:
a processor; and
a computer readable medium storing one or more instruction(s) arranged such that when executed the processor is caused to perform the method described above.

A further aspect of the present disclosure provides a magnetic sensor system for monitoring position, comprising:
a magnet mounted on a rotatable mechanism, wherein the rotatable mechanism is configured to actuate a first component in a linear direction;
at least one magnetic sensing device in the vicinity of the magnet, the at least one magnetic sensing device comprising:
   an angle sensor configured to detect an orientation of the magnetic field generated by the magnet as the rotatable mechanism is rotated; and
   a multi-turn sensor configured to detect a number of turns of the magnet as the rotatable mechanism is rotated;
wherein the at least on magnetic sensing device is configured to output a position of the first component in the linear direction based on the detected orientation of the magnetic field and the detected number of turns.

The angle sensor and the multi-turn sensor are preferably arranged on a first integrated circuit board.

The at least one magnetic sensing device may further comprise processing means for determining the position of the first component in the linear direction.

The angle sensor is preferably configured to detect the orientation of the magnetic field over a range of 0° to 180°.

### BRIEF DESCRIPTION OF THE DRAWINGS

The present disclosure will now be described by way of example only with reference to the accompanying drawings in which:

FIG. 1 is a schematic top view of a multi-turn sensor and a single turn sensor in accordance with an embodiment of the disclosure;

FIG. 2 is an example of a magnetic multi-turn sensor in accordance with embodiments of the disclosure;

FIGS. 3A-B illustrate an example of a magnetic sensor system in accordance with embodiments of the disclosure;

FIG. 4 illustrates another example of a magnetic sensor system in accordance with embodiments of the disclosure;

FIG. 5 illustrates a further example of a magnetic sensor system in accordance with embodiments of the disclosure;

FIGS. 6A-B illustrate a further example of a magnetic sensor system in accordance with embodiments of the disclosure;

FIGS. 7A-B illustrate a further example of a magnetic sensor system in accordance with embodiments of the disclosure;

FIGS. 8A-B illustrate a further example of a magnetic sensor system in accordance with embodiments of the disclosure;

FIGS. 9A-B illustrate a further example of a magnetic sensor system in accordance with embodiments of the disclosure;

FIG. 10 illustrates a further example of a magnetic sensor system in accordance with embodiments of the disclosure;

FIG. 11 illustrates a further example of a magnetic sensor system in accordance with embodiments of the disclosure;

FIG. 12 illustrates a further example of a magnetic sensor system in accordance with embodiments of the disclosure;

FIGS. 13A-B illustrate a further example of a magnetic sensor system in accordance with embodiments of the disclosure;

FIGS. 14A-B illustrate a further example of a magnetic sensor system in accordance with embodiments of the disclosure.

### DETAIL DESCRIPTION

Magnetic multi-turn and single turn sensors can be used to monitor the turn count and angular position of a rotating shaft. Such magnetic sensing can be applied to a variety of different applications, such as automotive applications, medical applications, industrial control applications, consumer applications, and a host of other applications which require information regarding a position of a rotating component.

The present disclosure provides a linear actuator apparatus, magnetic sensor system and method of use for detecting a position of a component driven by a rotatable mechanism in a linear direction, for example, a rack and pinion arrangement or a nut on a leadscrew. A magnetic sensing device comprising both a multi-turn (MT) sensor and a single turn (ST) sensor is provided within the same semiconductor package and placed in the vicinity of the rotatable mechanism. A magnet is also mounted on the rotatable mechanism, such that, as the mechanism rotates, a rotating magnetic field is generated. The MT sensor measures the number of turns of the rotating magnetic field, which is translated to the number of turns of the rotatable mechanism. The ST sensor measures the angle of the rotating magnetic field, which is translated to an angular position of the rotatable mechanism. As each turn of the rotatable mechanism will be translated to a specific amount of linear motion, the amount by which the rotational mechanism has turned is proportional to the distance travelled, and thus indicative of the linear position. Therefore, by placing a magnet and the magnetic sensing device in relation to the rotatable mechanism, with the multi-turn sensor providing the number of turns and the angle sensor providing the precise angular position within each turn, the measured rotational position can be translated to a corresponding linear position of the element being moved linearly as a result of the rotation.

Such an arrangement provides a compact and robust device for measuring linear positions, which removes the need for installing a linear position system on the linearly driven component.

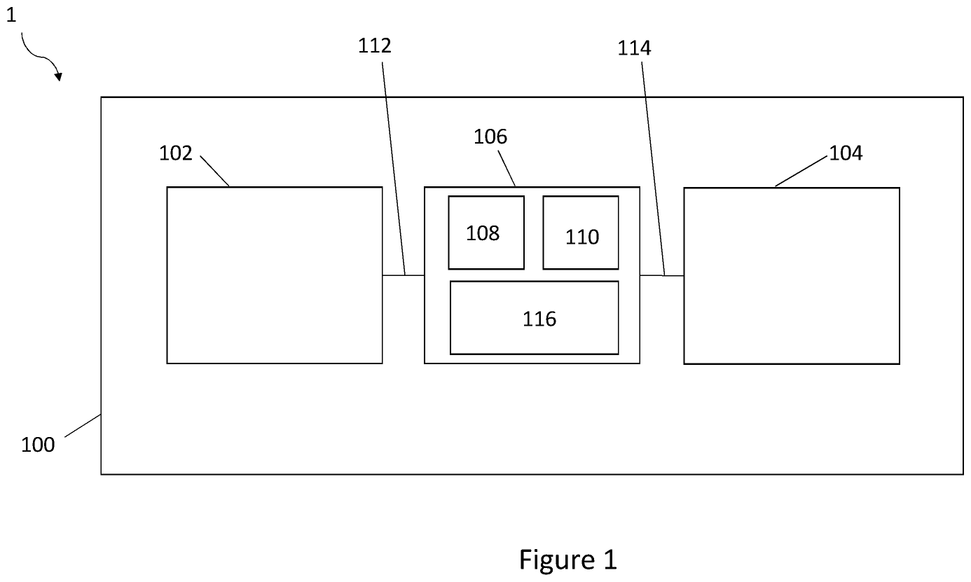

FIG. 1 illustrates a schematic block diagram of an example magnetic sensing device 1 that includes a multi-turn (MT) sensor 102 and a single turn (ST) sensor 104 provided in a single semiconductor package. The MT sensor 102 is preferably a giant magnetoresistive (GMR) or tunnel magnetoresistive (TMR) based MT sensor. The ST sensor 104 may be any magnetic ST sensor, for example, an anisotropic magnetoresistive (AMR), giant magnetoresistive (GMR) or tunnel magnetoresistive (TMR) based sensor, a Hall sensor or an inductive sensor. Preferably, the ST sensor 104 is an AMR single turn sensor configured to measure angular position over a 180° range to thereby provide an accurate angular position within each half turn counted by the MT sensor 102. Such an arrangement is simpler to implement, and generally more robust and tolerant of faults due to stray fields and the like. In general, a 180° AMR single turn sensor provides more precision than other magnetic angle sensor. For example, tunnel magnetoresistive (TMR) or giant magnetoresistive (GMR) based sensors often experience hysteresis problems, which can lead to different results for clockwise and anti-clockwise rotation.

The sensing device 1 also comprises a processing circuit 106, and an integrated circuit 100 on which the MT sensor 102, the ST sensor 104 and processing circuit 106 are disposed. The processing circuit 106 receives signals SMT 112 from the MT sensor 102 and processes the received signals to determine that the turn count using a turn count decoder 108, which will output a turn count representative of the number of turns of an external magnetic field (not shown) rotating in the vicinity of the MT sensor 102, for example, a magnetic field generated by a magnet mounted on a rotatable mechanism that is driving another element in a linear direction. Similarly, the processing circuit 106 may also receive signals SST 114 from the ST sensor 104 and process the received signals using an angle decoder 110 to output an angular position of the external magnetic field. As will be described in more detail below, the turn count and angular position may then be input to a position decoder 116 that is configured to calculate the linear position of the driven element based on the amount the rotatable mechanism that rotated.

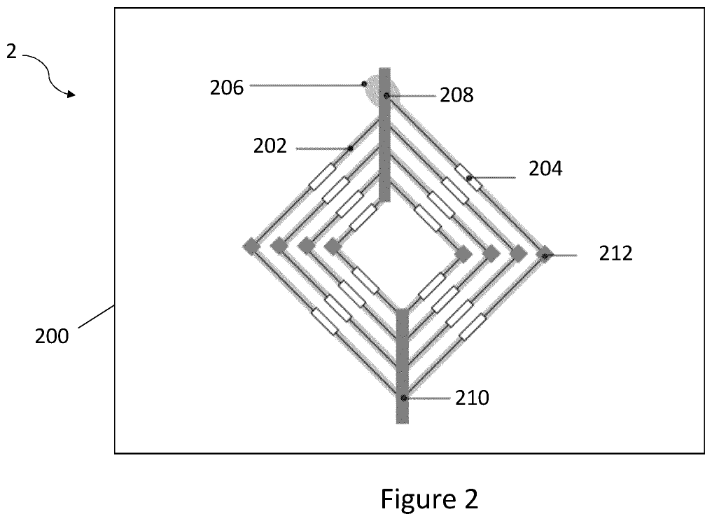

FIG. 2 shows an example of a magnetic strip 202 layout representation of a magnetic multi-turn sensor 2, shown here on an integrated circuit 200, which may provide the MT sensor 102 shown in FIG. 1.

In FIG. 2, the magnetic strip 202 comprises a plurality of magnetoresistive elements 204, preferably, GMR based magnetoresistive elements, or alternatively, TMR based magnetoresistive elements. In this example, the magnetic strip 202 is a GMR based magnetoresistive track that is physically laid out in a spiral configuration. As such, the magnetic strip 202 has a plurality of segments formed of magnetoresistive elements 204 arranged in series with each other. The magnetoresistive elements 204 act as variable resisters that change resistance in response to a magnetic alignment state. The end of the magnetic strip 202 is coupled to a domain wall generator (DWG) 206, and it will be appreciated that the DWG 206 may be coupled to either end of the magnetic strip 202. The DWG 206 generates domain walls in response to rotations in an external magnetic field, or the application of some other strong external magnetic field the operating magnetic window of the sensor 2. These domain walls are then injected into the magnetic strip 202 and as the magnetic domain changes, the resistance of the magnetoresistive elements 204 will also change due to the resulting change in magnetic alignment.

In order to measure the varying resistance of the magnetoresistive elements 204 as domain walls are generated, the magnetic strip 202 is electrically connected to a supply voltage VDD 208 and to ground GND 210 to apply a voltage between a pair of opposite corners. The corners halfway between the voltage supplies are provided with electrical connections 212 so as to provide half bridge outputs. As such, the multi-turn sensor 2 comprises multiple Wheatstone bridge circuits, with each half bridge 212 corresponding to one half turn or 180 degree rotation of an external magnetic field. Measurements of voltage at the electrical connections 212 can thus be used to measure changes in the resistance of the magnetoresistive elements 204, which can thus be used to determine the number of turns in the magnetic field, for example, by outputting the voltage measurements to the turn count decoder 108.

The example shown in FIG. 2 comprises 4 spiral windings and 8 half bridges 212, and is thus configured to count four full turns of an external magnetic field. However, it will be appreciated that a multi-turn sensor may have any number of spiral windings depending on the number of magnetoresistive elements 204. In general, multi-turn sensors can count as many turns as spiral windings. It will also be appreciated that the magnetoresistive elements 204 may be electrically connected in any suitable way so as to provide a sensor output representative of the changes in magnetic alignment state. For example, the magnetoresistive elements 204 may be connected in a matrix arrangement such as that described in US 2017/0261345, which is hereby incorporated by reference in its entirety.

As an alternative, the MT sensor 102 may be a closed-loop spiral, wherein the magnetoresistive elements of the inner and outer spiral winding are connected together to form a continuous spiral. Such an arrangement provides the effect of numerous spirals connected together, which enables a very high number of turns to be counted.

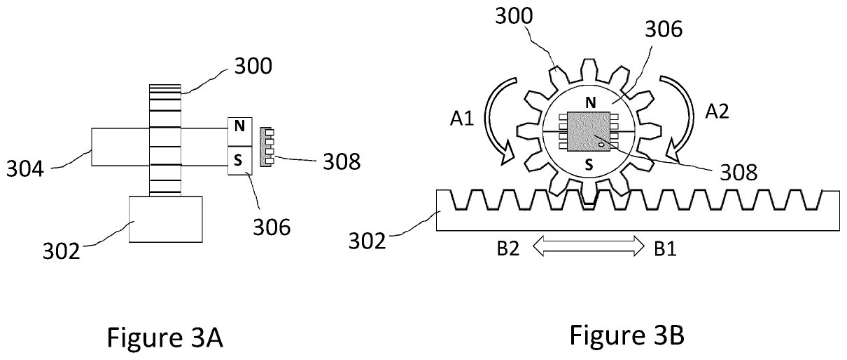

FIGS. 3A-3B illustrate a first example of a system for monitoring the linear position of a component driven by rotatable mechanism using a magnetic sensing device. FIG. 3A provides a side view of the system 3, whilst FIG. 3B shows a front view. In this example, a toothed rack 302 is driven in a linear direction by a toothed gear 300 that is rotatable by means of a rotating shaft 304, thereby forming a rack and pinion linear actuator. The teeth of the gear 300 and the rack 302 cooperate, such that, as the gear 300 is rotated, the rack 302 moves linearly in a corresponding way, with each degree of rotation by the gear 300 causing the rack 302 to translate a proportional distance in the linear direction. For example, when the gear 300 is rotated in a first direction A1, the rack is translated linearly in a first direction B1. If the gear 300 is then rotated in the opposite direction A2, the rack 302 will then translate linearly in the opposite direction B2. As such, rotation of the gear 300 can thus be used to drive the rack 302, or vice versa, to thereby drive some other device or system, for example, an elevator or sliding doors.

A single pole pair magnet 306 is mounted on the end of the rotating shaft 304 such that a rotating magnetic field is produced. A magnetic sensing device 308, which may be the magnetic sensing device 1 described with reference to FIG. 1, is located in the vicinity of the magnet 306. It will be appreciated that, in all of the examples described herein, the magnetic sensing device may be mounted to some other structure not shown, such that it is held in a fixed location relative to the rotating magnet.

As described previously, the rack 302 is moved linearly as the gear 300 rotates in one direction or the other. The magnetic sensing device 308 measures the rotating magnetic field generated by the magnet 306 to measure the amount by which the gear 300 has rotated in either direction, by counting the number of turns made and the absolute angular position within each turn, or preferably, within each half turn, which is then used to determine the linear position of the toothed rack 302. For example, the gear 300 may be turned 3 full turns in a clockwise direction, as measured by the MT sensor 102, and a further 45°, as measured by the ST sensor 104. Based on these measurements and the proportional relationship between the respective movements of the gear 300 and the rack 302, which may, for example, be based on the size and number of cooperating teeth, the distance travelled by the rack 302 and thus its linear position can be determined, for example, by the position decoder 116. If the gear 300 is then rotated 360° back in anti-clock wise direction, the MT sensor 102 will measure only 2 full turns, and the measured linear position of the rack 302 will be adjusted accordingly since it is known how far the rack 302 will travel per revolution of the gear 300.

This arrangement provides a simple and accurate way of measuring the linear position of the rack 302 without the need for a linear sensing system being installed on the rack itself. Furthermore, by placing a single sensor package 308 containing both the MT sensor and the ST sensor in the same position, no calibration is required to align the readings of the two sensors since both sensors are measuring the same rotating magnetic field.

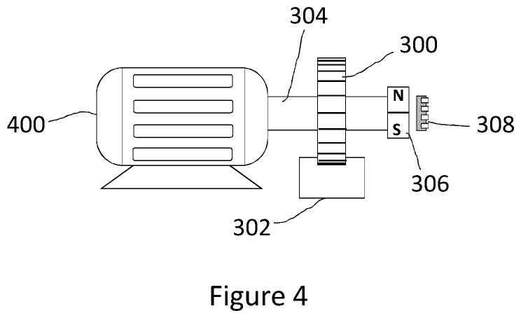

The rotating shaft 304 driving the gear 300 may be rotated using any suitable means, for example, using a motor 400, as shown in FIG. 4.

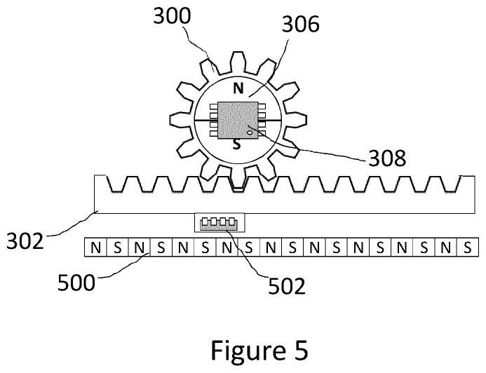

The arrangement described above may also be supplemented with a second magnetic sensing device, as illustrated by FIG. 5. Here, a second magnetic sensing device 502, which may comprise a Hall sensor or a magnetoresistive sensor, is mounted to the rack 302 such that it moves with the rack 302. An incremental linear track 500 comprising alternating north and south poles is provided in parallel to the rack 302. As the rack 302 moves linearly, the second magnetic sensing device 502 will detect the magnetic poles to incrementally measure the change in position as it moves along the track 502. In order to accurately measure the linear position, synchronisation is required such that one rotation correspond to movement over one period or half a period on the linear scale. This arrangement may be used in addition to or in place of the ST sensor of the first magnetic sensing device 308. Whilst a magnetic track 500 and sensor 502 are described, it will be appreciated that some other linear encoder may also be used, for example, an optical encoder.

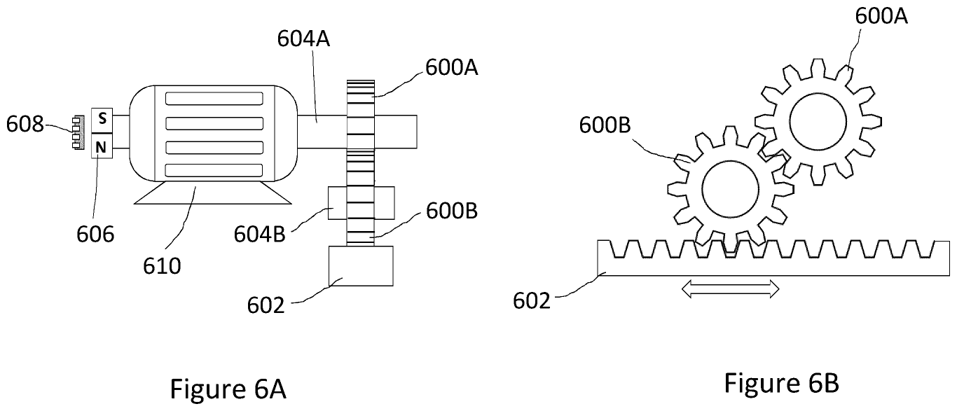

FIGS. 6A-6B illustrate another example of a system for monitoring the linear position of a component driven by rotatable mechanism using a magnetic sensing device.

In this example, the magnet 406 is mounted on the end of a first rotating shaft 604A being driven by a motor 601, although it will be appreciated that any suitable drive means may be used, which in turn drives a first toothed gear 600A. The teeth of the first gear 600A are arranged to cooperate with the teeth of a second toothed gear 600B, which may also be mounted on a second shaft 604B for further structural support. It will also be appreciated that the magnet 606 and magnetic sensing device 608 could alternatively be arranged on the second shaft 604B, such that it rotates with the second gear 600B. The second gear 600B is then arranged to cooperate with the teeth of a toothed rack 602 so as to cause linear movement thereof. As the shaft 604A rotates, the first gear 600A rotates and causes a corresponding rotation of the second gear 600B in the opposite direction, which in turn causes the rack 602 to translate a corresponding distance in the linear direction, as described above with reference to the example of FIGS. 3A-B.

As before, a magnetic sensing device 608 is located in the vicinity of the magnet 606 to thereby measure the magnetic field generated by the magnet 606 as the shaft 604A rotates. Based on the rotating magnetic field, the magnetic sensing device 608 measures the rotating magnetic field generated by the magnet 406 to measure the number of turns and absolute angular position of the first and second gears 600A, 600B, which can then be translated to a linear position of the rack 602, as described above.

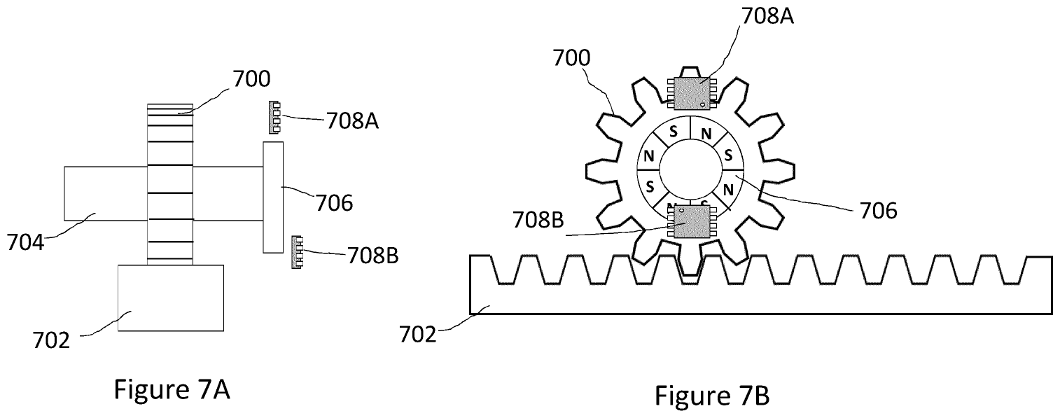

FIGS. 7A-7B illustrate a further example of a system for monitoring the linear position of a component driven by rotatable mechanism using a magnetic sensing device, similar to that of FIGS. 3A-3B, however, in this example, a multi-pole magnet 706 is mounted on the shaft 704. The use of a multi-pole magnet 706 helps to increase the resolution of the sensing device 708A, 708B, specifically, the ST sensor 104, since it provides multiple rotations of the magnetic field for each revolution of the gear 700. In such cases, the magnetic sensing device 708 may be mounted in two different positions, shown here at 708A and 708B. In the first position, the magnetic sensing device 708A is mounted in line with the magnet 706 such that it sits adjacent to its outer circumferential edge. It will be appreciated that whilst the sensing device 708A is shown above the magnet 706 in this example, it may be located at any position around the circumferential edge of the magnet 706. In the second position, the magnetic sensing device 708B is mounted in front of the magnet 706 such that it aligns with a pole pair. Again it will be appreciated that the magnetic sensing device 708B may be located at any radial position. In these positions, the magnetic sensing device 708A, 708B stays within the magnetic window of the magnetic field, wherein the change in magnetic field angle is directly proportional to the change in angle of the gear 700. Alternatively, the system may comprise two magnetic sensing devices 708A, 708B located at two different positions, each sensing device 708A, 708B comprising a MT sensor and a ST sensor in a single semiconductor package, as described above. This can help to improve fault tolerance in the event that a sensor in one of the packages fails.

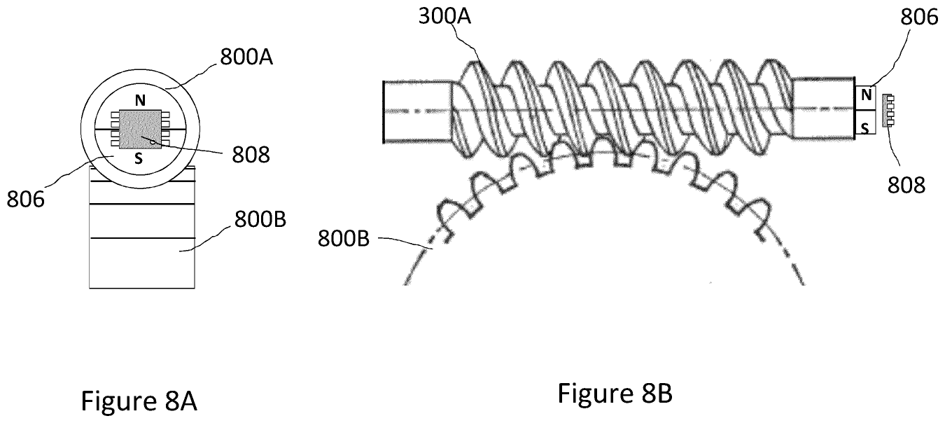

FIGS. 8A-8B illustrate a further example of a system for monitoring the linear position of a component driven by rotatable mechanism using a magnetic sensing device. In this example, the rotatable mechanism is a worm drive arrangement, wherein the magnet 806 and magnetic sensing device 808 are mounted on the end of a threaded screw 800A, also referred to as a “worm”, that is rotated to drive a cylindrical gear 800B, also referred to as a “worm gear”, wherein the worm gear 800B is driving the linear movement of a toothed rack (not shown) or similar, as described above. The magnetic sensing device 808 will measure the rotating magnetic field as the worm 800A rotates, to thereby measure the amount of rotation by the worm 800A. As each degree of rotation of the worm 800A will cause a proportional amount rotation by the worm gear 800B, which will in turn cause a proportional amount of linear movement by the driven component, the measured rotational position can be translated to a linear position.

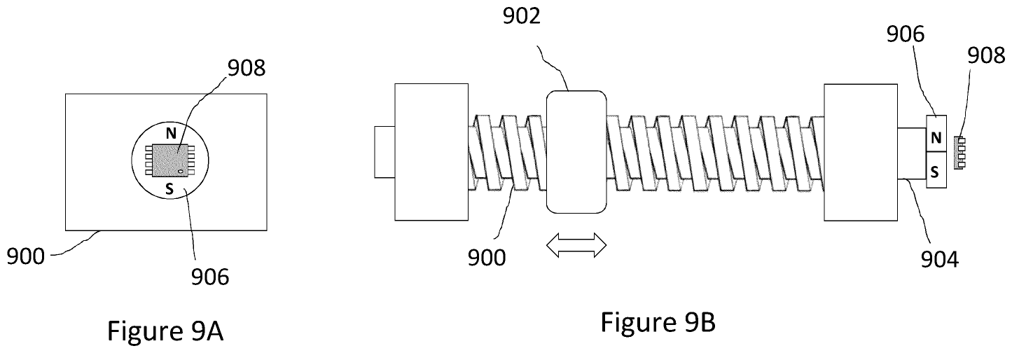

FIGS. 9A-9B illustrates another example of a system for monitoring the linear position of a component driven by rotatable mechanism using a magnetic sensing device. In this example, a nut 902 is driven in a linear direction by a rotational axis with leadscrew threads 900 that is rotatable by means of a rotating shaft 904. The nut 902 may have internal threads of ball screws that cooperate with the thread of the leadscrew 900, such that, as the leadscrew 900 is rotated, the nut 902 moves linearly along the leadscrew 900, with each degree of rotation by the leadscrew 900 causing the nut 902 to translate a proportional distance in the linear direction.

As before, a single pole pair magnet 906 is mounted on the end of the rotating shaft 904 such that a rotating magnetic field is produced. A magnetic sensing device 908, which may be the magnetic sensing device 1 described with reference to FIG. 1, is located in the vicinity of the magnet 906.

As described previously, the nut 902 is moved linearly as the leadscrew 900 rotates in one direction or the other. The magnetic sensing device 908 measures the rotating magnetic field generated by the magnet 906 to measure the amount by which the leadscrew 900 has rotated in either direction, by counting the number of turns made and the absolute angular position within each turn, or preferably, within each half turn, which is then used to determine the linear position of the nut 902. For example, the leadscrew 900 may be turned 2 full turns in a clockwise direction, as measured by the MT sensor 102, and a further 15°, as measured by the ST sensor 104. Based on these measurements and the proportional relationship between the respective movements of the leadscrew 900 and the nut 902, it may be determined, for example, by the position decoder 116, that the nut 902 has travelled 20 mm from left to right.

As described previously, this provides a simple and highly accurate way of measuring the linear position of the nut 902 without the need for a linear sensing system being installed on the nut itself. Furthermore, by placing a single sensor package 908 containing both the MT sensor and the ST sensor in the same position, no calibration is required to align the readings of the two sensors since both sensors are measuring the same rotating magnetic field.

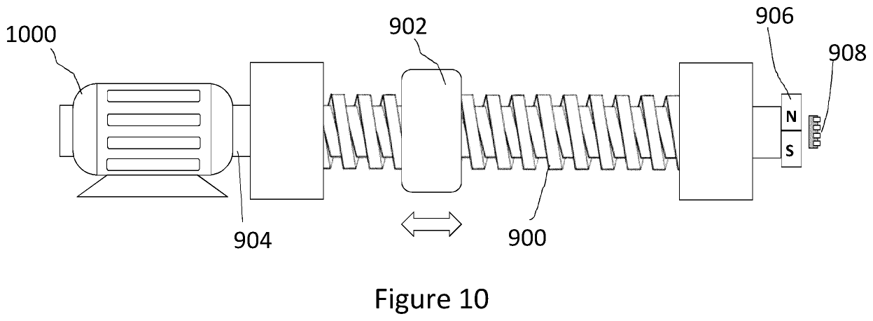

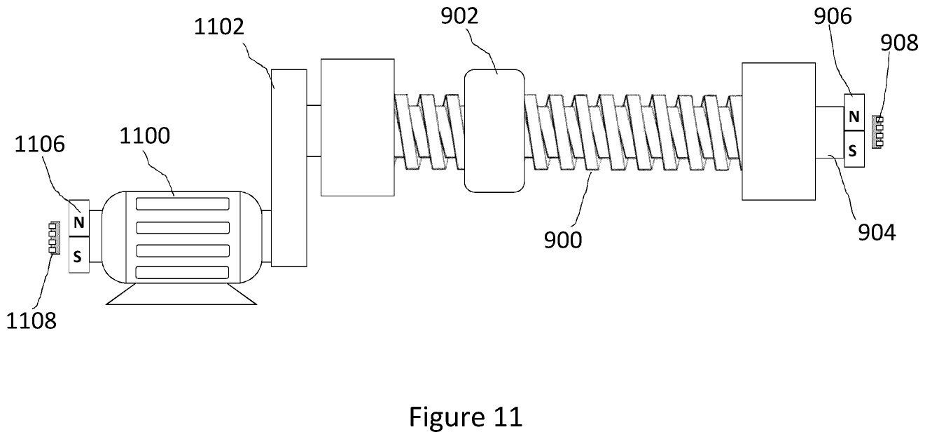

As shown by way of example in FIG. 10, the rotatable shaft 904 driving the leadscrew 900 may be rotated by a motor 1000, or some other suitable means. In another arrangement shown in FIG. 11, a motor 1100 is arranged to drive the shaft 904 via a gearbox 1102 or some other power transmission. In such an arrangement, a magnet 1106 may be mounted on a shaft of the motor 1100 with a magnetic sensing device 1108 located in the vicinity, to thereby measure the rotation of the motor 1100. This magnet 1106 and magnetic sensing device 1108 may be provided in place of or in addition to the magnet 906 and sensor 908 located on the leadscrew 900. As described previously, the measured rotation of the motor 1100 will cause a corresponding rotation of the leadscrew 900, which in turn will cause a corresponding linear movement by the nut 902. The amount of rotation by the motor 1100 as measured by the magnetic sensing device 1108 can thus be translated to a linear position of the nut 902.

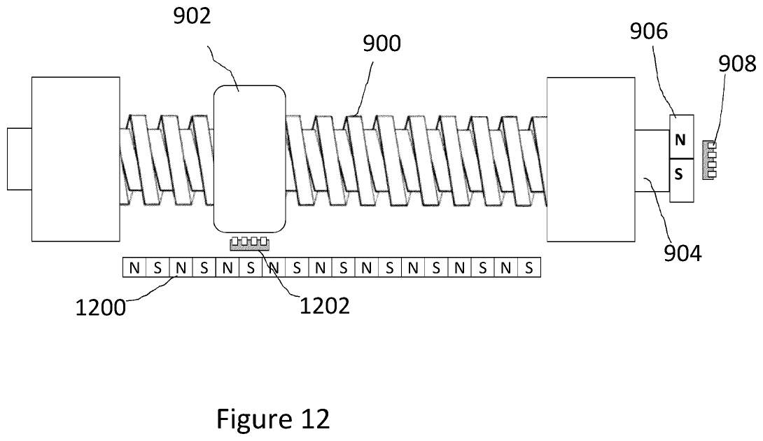

The arrangement described above with reference to FIGS. 9A-B may also be supplemented with a second magnetic sensing device, as illustrated by FIG. 12. Here, a second magnetic sensing device 1202, which may comprise a Hall sensor or a magnetoresistive sensor, is mounted to the nut 902 in some way such that it moves with the nut 902. An incremental linear track 1200 comprising alternating north and south poles is provided in parallel to the leadscrew 900. As the nut 902 moves linearly, the second magnetic sensing device 1202 will detect the magnetic poles to incrementally measure the change in position as it moves along the track 1202. In order to accurately measure the linear position, synchronisation is required such that one rotation correspond to movement over one period or half a period on the linear scale. This arrangement may be used in addition to or in place of the ST sensor of the first magnetic sensing device 908. Whilst a magnetic track 1200 and sensor 1202 are described, it will be appreciated that some other linear encoder may also be used, for example, an optical encoder.

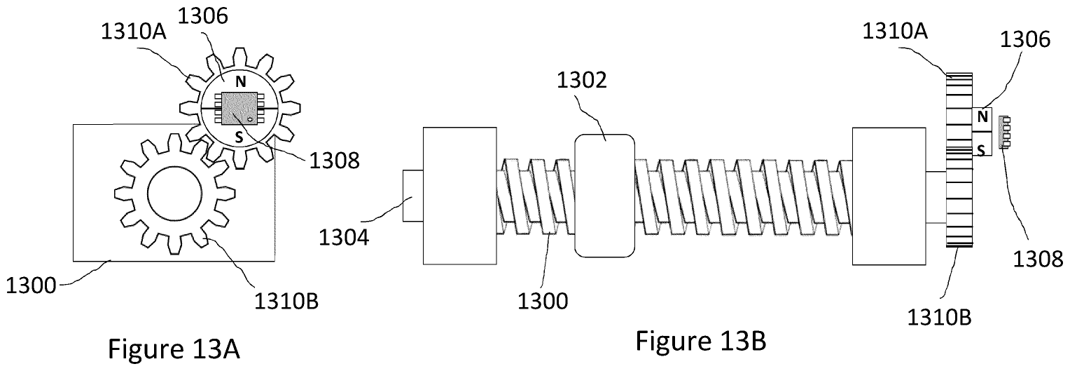

FIGS. 13A-B illustrate another example of a system for monitoring the linear position of a component driven by rotatable mechanism using a magnetic sensing device.

In this example, the magnet 1306 is mounted on the end of a first toothed gear 1310A. The teeth of the first gear 1310A are arranged to cooperate with the teeth of a second toothed gear 1310B, which is mounted on the shaft 1304 of the leadscrew 1300, such that the first toothed gear 1310A, the second toothed gear 1310B and the leadscrew 1300 all rotate together. It will be appreciated that the first toothed gear 1310A may be driven by some other means, such the rotation of the first toothed gear 1310A drives the rotation of the second toothed gear 1310B and the leadscrew 1300. Alternatively, the shaft 1304 of the leadscrew 1300 may be driven by some other means such as a motor, such that the rotation of the leadscrew 1300 drives the rotation of the first and second gears 1310A, 1310B.

As before, a magnetic sensing device 1308 is located in the vicinity of the magnet 1306 to thereby measure the magnetic field generated by the magnet 1306 as the first toothed gear 1310A rotates. Based on the rotating magnetic field, the magnetic sensing device 1308 measures the rotating magnetic field generated by the magnet 1306 to measure the number of turns and absolute angular position of the first and second gears 1300A, 1300B, and the leadscrew 1300, which can then be translated to a linear position of the nut 902, as described above.

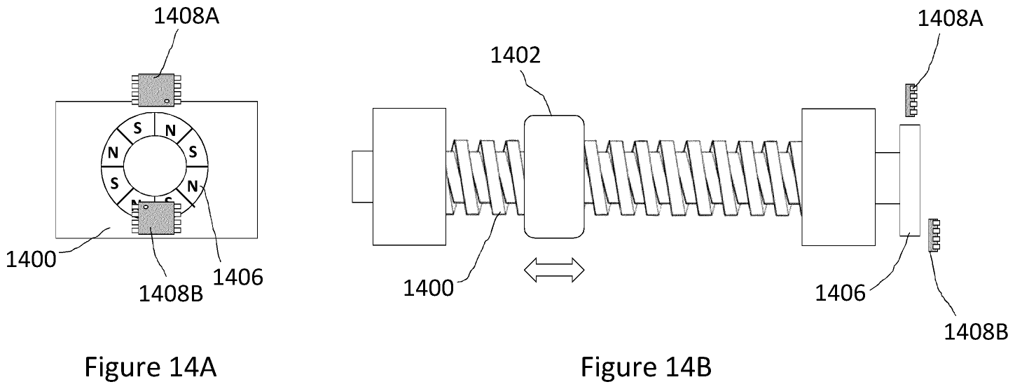

FIGS. 14A-B illustrate a further example of a system for monitoring the linear position of a component driven by rotatable mechanism using a magnetic sensing device, similar to that of FIGS. 9A-B, however, in this example, a multi-pole magnet 1406 is mounted on the shaft 1404. The use of a multi-pole magnet 1406 helps to increase the resolution of the sensing device 1408A, 1408B, specifically, the ST sensor 104, since it provides multiple rotations of the magnetic field for each revolution of the leadscrew 1400. In such cases, the magnetic sensing device 1408 may be mounted in two different positions, shown here at 1408A and 1408B. In the first position, the magnetic sensing device 1408A is mounted in line with the magnet 1406 such that it sits adjacent to its outer circumferential edge. It will be appreciated that whilst the sensing device 1408A is shown above the magnet 1406 in this example, it may be located at any position around the circumferential edge of the magnet 1406. In the second position, the magnetic sensing device 1408B is mounted in front of the magnet 1406 such that it aligns with a pole pair. Again it will be appreciated that the magnetic sensing device 1408B may be located at any radial position. In these positions, the magnetic sensing device 1408A, 1408B stays within the magnetic window of the magnetic field, wherein the change in magnetic field angle is directly proportional to the change in angle of the gear 1400. Alternatively, the system may comprise two magnetic sensing devices 1408A, 1408B located at two different positions, each sensing device 1408A, 1408B comprising a MT sensor and a ST sensor in a single semiconductor package, as described above. This can help to improve fault tolerance in the event that a sensor in one of the packages fails.

It will be appreciated that the method and system for measuring linear position described herein may be applied to a number of different applications in which a component is driven in a linear direction by a rotational mechanism, including but not limited to, a clutch actuator, transmission actuators, seat position/rotation, electric sliding doors, sun roofs, electric sliding windows, tilt actuators, active suspension fork lift steering (tilt, position, extension), window blinds, window shutters, printers, elevators, machining equipment (a lathe machine, milling, wire cutting), a 3D printer, and dispensing/injection equipment.

The use of magnetic sensing device and magnet arrangement has significant advantages over the existing linear measurement systems currently used in such applications, in that it provides a significantly smaller, less complex and cheaper system. Furthermore, the magnetic sensor does not require power in order to measure the number of turns and angular position, and can therefore continue to output measurements if power is lost elsewhere.

Various modifications, whether by way of addition, deletion and/or substitution, may be made to all of the above described embodiments to provide further embodiments, any and/or all of which are intended to be encompassed by the appended claims

For example, in any of the arrangements described above, a shield in the form of cap or the like made from ferromagnetic material may be placed around the magnet and magnetic sensing device to protect it from stray magnetic fields that may disturb the turn count and angle measurements.

In other examples, the system may be provided with an electromagnet that initializes the magnetic sensing device when the rotatable mechanism and driven element are at a starting position, for example, when the driven element is at one of its end positions or in its middle position. Preferably, the electromagnet will be located in proximity to the MT sensor to align the magnetisation of all of the magnetoresistive elements in one direction. That is to say, when the driven element is at its starting position, the electromagnet may initialize the magnetic sensor such that this position corresponds to a zero turn count reading by the MT sensor, and a zero degree angle reading by ST sensor. This then provides the starting point from which the turn count and angle are measured as the rotatable mechanism rotates to drive the element linearly.

1. A linear actuator apparatus, comprising:
a first component for actuating a system in a linear direction;
a rotatable mechanism configured to drive the first component in the linear direction;
a magnet mounted on the rotatable mechanism; and
at least one magnetic sensing device in a vicinity of the magnet, the at least one magnetic sensing device comprising:
an angle sensor configured to detect an orientation of a magnetic field generated by the magnet as the rotatable mechanism is rotated; and
a multi-turn sensor configured to detect a number of turns of the magnet as the rotatable mechanism is rotated;
wherein the at least on magnetic sensing device is configured to output a position of the first component in the linear direction based on the detected orientation of the magnetic field and the detected number of turns.

2. A linear actuator apparatus according to claim 1, wherein the angle sensor and the multi-turn sensor are arranged on a first integrated circuit board.

3. A linear actuator apparatus according to claim 1, wherein the at least one magnetic sensing device further comprises processing means for determining the position of the first component in the linear direction.

4. A linear actuator apparatus according to claim 1, wherein the angle sensor is configured to detect the orientation of the magnetic field over a range of 0° to 180°.

5. A linear actuator apparatus according to claim 1, wherein the angle sensor is one of: an anisotropic magnetoresistive (AMR) based single turn sensor, a giant magnetoresistive (GMR) based single turn sensor, a tunnel magnetoresistive (TMR) based single turn sensor, a Hall effect sensor and an inductive sensor.

6. A linear actuator apparatus according to claim 1, wherein the multi-turn sensor is a giant magnetoresistive (GMR) based multi-turn sensor, or a tunnel magnetoresistive (TMR) based multi-turn sensor.

7. A linear actuator apparatus according to claim 1, wherein the multi-turn sensor comprises a plurality of magnetoresistive elements electrically connected in series and physically laid out in a spiral configuration.

8. (canceled)

9. A linear actuator apparatus according to claim 1, wherein the rotatable mechanism comprises a first cylindrical gear, and wherein the first component comprises a linear gear configured to cooperate with the first cylindrical gear, such that rotation of the first cylindrical gear causes the linear gear to translate in a linear direction.

10. A linear actuator apparatus according to claim 9, wherein the rotatable mechanism further comprises a second cylindrical gear configured to cooperate with the first cylindrical gear, such that rotation of the second cylindrical gear causes a corresponding rotation of the first cylindrical gear, wherein the magnet is mounted in relation to the first cylindrical gear or the second cylindrical gear.

11. (canceled)

12. A linear actuator apparatus according to claim 1, wherein the rotatable mechanism comprises a threaded screw and a cylindrical gear, wherein the threaded screw is configured to cooperate with the cylindrical gear such that rotation of the threaded screw causes a rotation of the cylindrical gear, wherein the first component comprises a linear gear configured to cooperate with the cylindrical gear, such that rotation of the cylindrical gear causes the linear gear to translate in a linear direction.

13. (canceled)

14. A linear actuator apparatus according to claim 1, wherein the rotatable mechanism comprises a threaded shaft, and wherein the first component comprises an annular part arranged around the threaded shaft and configured to engage with the threaded shaft such that rotation of the threaded shaft causes the annular part to translate in a linear direction along the threaded shaft, wherein the threaded shaft comprises a gear arrangement configured to drive the rotation of the threaded shaft.

15. (canceled)

16. A linear actuator apparatus according to claim 1, wherein the magnet is a single pole pair magnet or a multi-pole magnet.

17. A linear actuator apparatus according to claim 1, wherein the magnet is a multi-pole ring magnet, and wherein the at least one magnetic sensing device is located in a first position adjacent to an outer circumferential edge of the multi-pole magnet, and/or a second position in front of the multi-pole magnet aligned with a pole pair.

18. (canceled)

19. (canceled)

20. (canceled)

21. (canceled)

22. A linear actuator apparatus according to claim 1, further comprising a linear sensor system, wherein the linear sensor system comprises:
an incremental linear track comprising a first number of magnetic poles; and
a further magnetic sensing device configured to count the first number of magnetic poles.

23. (canceled)

24. A method of monitoring position using a magnetic sensing device, wherein a magnet is mounted on a rotatable mechanism configured to actuate a first component in a linear direction, the method comprising:
detecting, using an angle sensor, an orientation of a magnetic field generated by the magnet as the rotatable mechanism is rotated;
detecting, using a multi-turn sensor, number of turns of the magnet as the rotatable mechanism is rotated; and
determining a position of the first component in the linear direction based on the detected orientation and detected number of turns.

25. A method according to claim 24, wherein determining the position of the first component in the linear direction comprises:
determining an amount of rotation by the rotatable mechanism in a first direction; and
determining a distance travelled by the first component in the linear direction based on the determined amount of rotation.

26. (canceled)

27. A method according to claim 24, wherein the detecting the orientation of the magnetic field comprises detecting the orientation of the magnetic field over a range of 0° to 180°.

28. (canceled)

29. A computer system comprising:
a processor; and
a computer readable medium storing one or more instruction(s) arranged such that when executed the processor is caused to perform the method according to claim 24.

30. A magnetic sensor system for monitoring position, comprising:
a magnet mounted on a rotatable mechanism, wherein the rotatable mechanism is configured to actuate a first component in a linear direction;
at least one magnetic sensing device in a vicinity of the magnet, the at least one magnetic sensing device comprising:
an angle sensor configured to detect an orientation of a magnetic field generated by the magnet as the rotatable mechanism is rotated; and
a multi-turn sensor configured to detect a number of turns of the magnet as the rotatable mechanism is rotated;
wherein the at least on magnetic sensing device is configured to output a position of the first component in the linear direction based on the detected orientation of the magnetic field and the detected number of turns.

31. A magnetic sensor system according to claim 30, wherein the angle sensor and the multi-turn sensor are arranged on a first integrated circuit board.

32. (canceled)

33. (canceled)
